(19) United States
(12) Patent Application Publication
(10) Pub. No.: US 2021/0187882 A1
(43) Pub. Date: Jun. 24, 2021

(54) Heat treatment of 3D-printed objects

(71) Applicant: INTAMSYS TECHNOLOGY CO., LTD., Dongguan, Guangdong (CN)

(72) Inventors: Xianming Dong, Dongguan, Guangdong (CN); Chengchao Han, Dongguan, Guangdong (CN); Shaowu Qin, Dongguan, Guangdong (CN)

(21) Appl. No.: 16/762,500

(22) PCT Filed: Dec. 4, 2017
(86) PCT No.: PCT/CN2017/114414

§ 371 Date: May 8, 2020

(51) Int. Cl. B29C 71/02; B29C 64/35; B33Y 40/20; B33Y 70/00

(52) U.S. Cl. CPC B29C 71/02; B29C 64/35; B29K 2071/00; B33Y 70/00; B33Y 40/20

(57) ABSTRACT

A process for heat treating a 3D-printed object includes enclosing a 3D-printed object in a semisolid capsule; curing the semisolid capsule to form a solid capsule; heat-treating the solid capsule until amorphous regions of the 3D-printed object become elastomeric state; cooling the solid capsule; and removing the heat-treated 3D-printed object from the solid capsule.

### BACKGROUND OF THE INVENTION

### 1. Field of the Invention

The invention relates to heat treatment and more particularly to a process for heat treating a 3D-printed object.

### 2. Description of Related Art

Three-dimensional (3D) printing processes are widely employed in many applications due to advancement of 3D printing technologies. A typical 3D-printing process comprises the steps of creating a digital 3D model with a computer-aided design (CAD) package, converts the 3D model into a series of thin layers and produces a file containing instructions tailored to a specific type of 3D printer, and printing the file with 3D printing client software which loads the file and uses it to instruct the 3D printer during the 3D printing process. As a result, a 3D object is created.

3D-printing involves successively adding material layer by layer and that is why it is also called additive manufacturing. Problems of 3D-printing of an object of polymer include different cooling speeds of parts of the object, and significant stress in the object. The stress is a representation of disequilibrium conformation in molecular links of the polymer in the melting process. The disequilibrium conformation does not disappear after the object has been cooled. Thus, equilibrium conformation is not reached. The undesired stress not only deforms or even breaks the 3D-printed object in storage or use but also adversely affect chemical properties, thermal performance and appearance of the object.

Typically, the 3D-printed object is kept at a predetermined temperature for an extended period of time to eliminate stress. The 3D-printed object is exposed to a temperature less than the glass transition temperature for preventing the object from being deformed in elevated temperature. However, there is no significant stress decrease because dynamic energy of the molecules of polymer is relative low in the glassy state. To the worse, the 3D-printed object may be deformed if the temperature continues to increase. Unfortunately, there is no conventional process of preventing a 3D-printed object from being deformed when the object is exposed to an elevated temperature.

Thus, the need for improvement still exists.

### SUMMARY OF THE INVENTION

The invention has been made in an effort to solve the problems of the conventional art including being incapable of preventing a 3D-printed object from being deformed when the object is exposed to elevated temperature by providing a process for heat treating a 3D-printed object having novel and nonobvious characteristics.

To achieve above and other objects of the invention, the invention provides a process for heat treating a 3D-printed object, comprising the steps of (a) enclosing a 3D-printed object in a semisolid capsule; (b) curing the semisolid capsule to form a solid capsule wrapping around the 3D-printed object; (c) heat-treating the solid capsule until amorphous regions of the 3D-printed object become elastomeric state; (d) cooling the solid capsule; and (e) removing the heat-treated 3D-printed object from the solid capsule.

Preferably, the 3D-printed object is made from a crystalline polymer having amorphous regions or an amorphous polymer.

Preferably, the 3D-printed object is made from a crystalline polymer having amorphous regions, and the heat-treating is taken at a temperature greater than a temperature of converting the crystalline polymer into a glass but less than a viscous flow temperature of the crystalline polymer.

Preferably, the crystalline polymer is at least one of poly-ether-ether-ketone (PEEK) and a composite material thereof, a polyamide (PA) and a composite material thereof, and polyethylene terephthalate (PET) and a composite material thereof.

Preferably, the 3D-printed object is made from an amorphous polymer, and the heat-treating is taken at a temperature greater than a temperature of converting the amorphous polymer into a glass but less than a viscous flow temperature of the amorphous polymer.

Preferably, the semisolid capsule is gypsum emulsion, sodium metasilicate, silicone, or a combination thereof.

Preferably, the heat-treating is air heating, radiation heating, liquid heating, induction heating, or a combination thereof.

Preferably, further comprises the step of removing gas molecules from the semisolid capsule prior to step (c) of curing the semisolid capsule.

Preferably, step (e) of removing the heat-treated 3D-printed object from the solid capsule involves knocking or pressurized washing the solid capsule, or dissolving the solid capsule in a chemical solution.

Preferably, the heat-treating is taken by increasing temperature at a rate of 20-200° C. per hour, and after temperature has reached 200° C., the temperature is kept for 1 to 5 hours.

The invention has the following advantageous effects in comparison with the prior art: the amorphous regions of the heat-treated object become elastomeric state. The stress of the 3D-printed object is eliminated. The size of the 3D-printed object is more stable. The solid capsule with the 3D-printed object enclosed therein greatly decreases deformation of the 3D-printed object in the heat treatment. Further, the disequilibrium conformation of the 3D-printed object in the solid capsule changes to an equilibrium state. The heat treatment is particularly suitable for 3D-printed objects liable to deformation in a high temperature condition. Its operation is simple and effects are significant.

The above and other objects, features and advantages of the invention will become apparent from the following detailed description taken with the accompanying drawings.

### BRIEF DESCRIPTION OF THE DRAWINGS

FIG. 1 is a flow chart of a process for heat treating a 3D-printed object according to the invention; and

FIG. 2 is a table showing results of each of the created 3D-printed objects S1, S2, S3, D1, D2 and D3 being subjected to tensile strength, Young's modulus, breaking time and crystallinity tests.

### DETAILED DESCRIPTION OF THE INVENTION

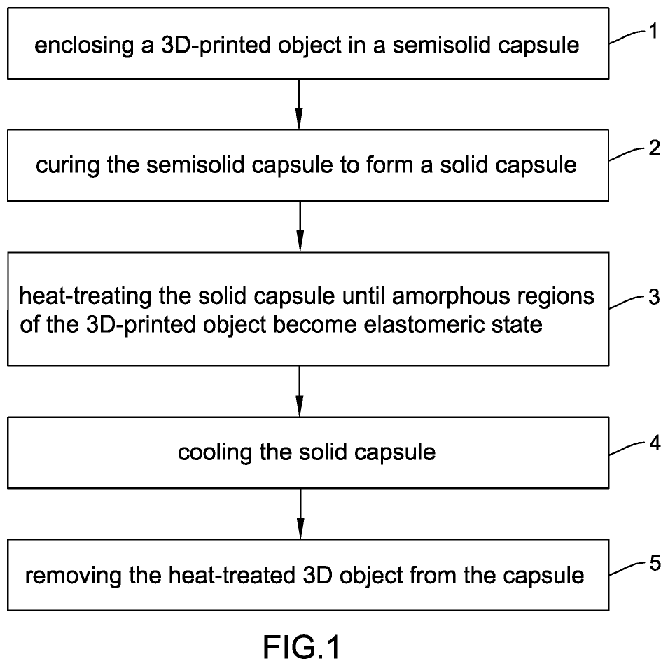

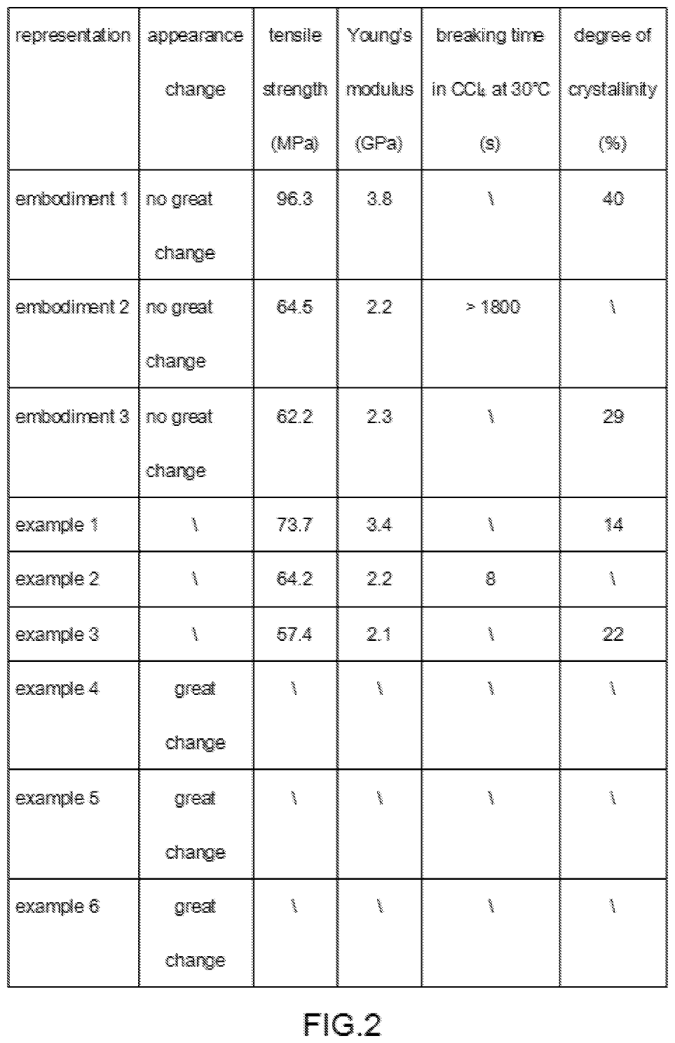

Referring to FIGS. 1 to 2, a process for heat treating a 3D-printed object in accordance with the invention comprises the steps of (1) enclosing a 3D-printed object in a semisolid capsule, (2) curing the semisolid capsule to form a solid capsule wrapping around the 3D-printed object, (3) heat-treating the solid capsule until amorphous regions of the 3D-printed object become elastomeric state, (4) cooling the solid capsule, and (5) removing the heat-treated 3D-printed object from the solid capsule.

Prior to step (2) of curing the semisolid capsule, there is a step of removing gas molecules from the semisolid capsule and it can be achieved by means of a vacuum pump or the like so that the semisolid capsule may wrap around the 3D-printed object, i.e., being adhered to each other. This ensures high precision of the heat-treated 3D-printed object.

Prior to step (3) of heat-treating the solid capsule, there is a step of removing humidity from the solid capsule containing the 3D-printed object.

The semisolid capsule is gypsum emulsion, sodium metasilicate, silicone, or a combination thereof. Portions of the semisolid capsule may fill pores of the 3D-printed object so that it becomes solid after being cured and the solid capsule becomes a mold with the 3D-printed object contained therein.

In one embodiment, the 3D-printed object is made from a crystalline polymer. Specifically, the 3D-printed object is formed of crystalline polymer having amorphous regions. Heat treatment temperature is greater than the glass transition temperature but less than the viscous flow temperature of the crystalline polymer. Thus, the amorphous regions of the crystalline polymer are viscous and molecules in the amorphous regions may freely rotate and move. And in turn, it can eliminate stress between the molecules. The molecules in the amorphous regions may be rearranged to form a second crystallization when the crystalline polymer is exposed to a temperature greater than the glass transition temperature but less than the viscous flow temperature of the crystalline polymer. As a result, density of the 3D-printed object is increased greatly and chemical properties and thermal performance of the polymer are improved. In the embodiment, the glass transition temperature is a temperature at which the amorphous regions of the crystalline polymer are converted into elastomeric state ones, and the viscous flow temperature of the crystalline polymer is a temperature at which the elastomeric state amorphous regions of the crystalline polymer are converted into viscous ones.

In one embodiment, the 3D-printed object is made from an amorphous polymer. Heat treatment temperature is greater than the glass transition temperature but less than the viscous flow temperature of the amorphous polymer. Thus, stress between the molecules can be completely eliminated. Further, it ensures high precision of the size of the heat-treated 3D-printed object because the 3D-printed object is heat-treated in the mold formed by the solid capsule.

Step (5) of removing the heat treated 3D-printed object from the solid capsule involves knocking or pressurized washing the solid capsule, or dissolving the solid capsule in a chemical solution. It is noted that care should be taken to prevent the 3D-printed object from being dissolved and corroded by the solvent in the solution.

In one embodiment, the heat treatment temperature is increased from 20-200° C. per hour. After has reached 200° C., the temperature is kept for 1 to 5 hours and the keeping time depends on the temperature increasing rate. Temperature increase time varies based on the materials and the sizes of the object as long as the amorphous regions of the 3D-printed object become elastomeric state and the molecules in the amorphous regions can be rearranged.

The invention does not limit the creations of the 3D-printed object. For example, the 3D-printed object can be created by fused deposition modeling (FDM), selective laser sintering (SLS), or the like. Alternatively, it may be obtained from markets.

### Embodiment 1

A 3D-printed object formed of poly-ether-ether-ketone (PEEK) is placed in a heating vessel. Next, prepared gypsum emulsion is poured into the heating vessel to immerse the 3D-printed object. Next, the heating vessel is placed in a vacuum chamber and a vacuum pump is activated to remove air from the vacuum chamber. Vacuum quality is less than 100 Pa and operating time is less than 5 minutes until no bubbles are generated.

After the air has been removed, the heating vessel is deactivated for 24 hours so that the gypsum emulsion may be cured. As a result, a 3D-printed object enclosed by gypsum is formed.

Next, the heating vessel in placed in an oven to heat at 120° C. for 6-10 hours so that water in both the gypsum and the 3D-printed object can be completely extracted. Thereafter, the heating vessel is heated at a rate of 20-200° C. per hour until temperature of the heating vessel reaches 180-320° C. The heating vessel is kept at the temperature for 1 to 5 hours. Thereafter, the heating vessel is cooled at a rate of 20-200° C. per hour until temperature of the heating vessel reaches the room temperature. Next, a pressure washer is used to shoot a high-velocity stream of water on the solid gypsum to remove the gypsum from the 3D-printed object. As a result, a 3D-printed object S1 is created.

### Embodiment 2

A 3D-printed object formed of polycarbonate (PC) is placed in a heating vessel. Next, prepared gypsum emulsion is poured into the heating vessel to immerse the 3D-printed object. Next, the heating vessel is placed in a vacuum chamber and a vacuum pump is activated to remove air from the vacuum chamber. Vacuum quality is less than 100 Pa and operating time is less than 5 minutes until no bubbles are generated.

After the air has been removed, the heating vessel is deactivated for 24 hours so that the gypsum emulsion may be cured. As a result, a 3D-printed object enclosed by gypsum is formed.

Next, the heating vessel in placed in an oven to heat at 120° C. for 5-10 hours so that water in both the gypsum and the 3D-printed object can be completely extracted. Thereafter, the heating vessel is heated at a rate of 20-200° C. per hour until temperature of the heating vessel reaches 150-180° C. The heating vessel is kept at the temperature for 1 to 5 hours. Thereafter, the heating vessel is cooled at a rate of 20-200° C. per hour until temperature of the heating vessel reaches the room temperature. Next, a pressure washer is used to shoot a high-velocity stream of water on the solid gypsum to remove the gypsum from the 3D-printed object. As a result, a 3D-printed object S2 is created.

### Embodiment 3

A 3D-printed object formed of polyamide (PA) is placed in a heating vessel. Next, prepared gypsum emulsion is poured into the heating vessel to immerse the 3D-printed object. Next, the heating vessel is placed in a vacuum chamber and a vacuum pump is activated to remove air from the vacuum chamber. Vacuum quality is less than 100 Pa and operating time is less than 5 minutes until no bubbles are generated.

After the air has been removed, the heating vessel is deactivated for 24 hours so that the gypsum emulsion may be cured. As a result, a 3D-printed object enclosed by gypsum is formed.

Next, the heating vessel in placed in an oven to heat at 100° C. for 5-10 hours so that water in both the gypsum and the 3D-printed object can be completely extracted. Thereafter, the heating vessel is heated at a rate of 20-200° C. per hour until temperature of the heating vessel reaches 150-180° C. The heating vessel is kept at the temperature for 1 to 5 hours. Thereafter, the heating vessel is cooled at a rate of 20-200° C. per hour until temperature of the heating vessel reaches the room temperature. Next, a pressure washer is used to shoot a high-velocity stream of water on the solid gypsum to remove the gypsum from the 3D-printed object. As a result, a 3D-printed object S3 is created.

### Example 1

A 3D-printed object D1 formed of poly-ether-ether-ketone (PEEK) not heat-treated by the process illustrated by embodiment 1 is created.

### Example 2

A 3D-printed object D2 formed of polycarbonate (PC) not heat-treated by the process illustrated by embodiment 2 is created.

### Example 3

A 3D-printed object D3 formed of polyamide (PA) not heat-treated by the process illustrated by embodiment 3 is created.

### Example 4

A 3D-printed object formed of poly-ether-ether-ketone (PEEK) 1 is placed in a heating vessel. Next, the heating vessel is placed in an oven to heat at 120° C. for 6-10 hours so that water in the 3D-printed object can be completely extracted. Thereafter, the oven is heated at a rate of 20-200° C. per hour until temperature of the oven reaches 180-320° C. The heating vessel is kept at the temperature for 1 to 5 hours. Thereafter, the oven is cooled at a rate of 20-200° C. per hour until temperature of the oven reaches the room temperature. Finally, a 3D-printed object D4 is removed from the oven.

### Example 5

A 3D-printed object formed of polycarbonate (PC) is placed in a heating vessel. Next, the heating vessel is placed in an oven to heat at 120° C. for 5-10 hours so that water in the 3D-printed object can be completely extracted. Thereafter, the oven is heated at a rate of 20-200° C. per hour until temperature of the oven reaches 150-180° C. The heating vessel is kept at the temperature for 1 to 5 hours. Thereafter, the oven is cooled at a rate of 20-200° C. per hour until temperature of the oven reaches the room temperature. Finally, a 3D-printed object D5 is removed from the oven.

### Example 6

A 3D-printed object formed of polyamide (PA) is placed in a heating vessel. Next, the heating vessel is placed in an oven to heat at 100° C. for 5-10 hours so that water in the 3D-printed object can be completely extracted. Thereafter, the oven is heated at a rate of 20-200° C. per hour until temperature of the oven reaches 120-210° C. The heating vessel is kept at the temperature for 1 to 5 hours. Thereafter, the oven is cooled at a rate of 20-200° C. per hour until temperature of the oven reaches the room temperature. Finally, a 3D-printed object D6 is removed from the oven.

Each of the created 3D-printed objects S1, S2, S3, D1, D2 and D3 are subjected to tensile strength, Young's modulus, breaking time and crystallinity tests and the test results are tabulated in the table of FIG. 2.

Crystallinity test of the crystalline polymer is detailed below. Differential scanning calorimetry (DSC) is used. DSC is a thermoanalytical technique in which the difference in the amount of heat required to increase the temperature of a representation and reference is measured as a function of temperature. Both the representation and reference are maintained at nearly the same temperature throughout the experiment.

Heat will be generated when a crystalline polymer melts and DSC is used on the melting crystalline polymer to obtain a melting peak curve and an area under curve. Thus, a heat capacity is calculated. The heat capacity is the melting heat of crystalline regions of the crystalline polymer. The melting heat of the crystalline polymer is proportional to degree of crystallinity thereof. That is, the higher the degree of crystallinity, the greater the melting heat as expressed in the following equation:

$$θ = \frac{Δ Hf}{Δ {Hf}^{ *} } \times 1 \; 00 \%$$

where θ is degree of crystallinity in percentage, ΔHf is melting heat of the representation, and ΔHf* is melting heat of the crystalline polymer having a 100% degree of crystallinity. The data can be obtained by looking at reference books.

For ductile materials such as PEEK and PA used in embodiments 1, 2 and 3 and examples 1 and 2, tensile strength is the maximum stress that a material can withstand while being stretched or pulled before breaking. That is, the greater the tensile strength, the greater the capability of the material withstanding stretch or pull. And in turn, the stress is substantially eliminated and the mechanical strength of the 3D-printed object is increased greatly. In short, changes of the tensile strength represent the extent of the stress elimination. Young's modulus is a mechanical property that measures the stiffness of a solid material. It defines the relationship between stress (force per unit area) and strain (proportional deformation) in a material in the linear elasticity regime of a uniaxial deformation. That is, the greater the Young's modulus, the greater the stiffness. Thus, both tensile strength and Young's modulus can be used to represent the mechanical strength of the 3D-printed object.

For brittle materials such as polycarbonate (PC) used in the above embodiments, it is liable to breakage due to stress. In detail, a 3D-printed object may be gradually broken due to stress. Solvent can be used to test breakage of PC due to stress. Thus, breaking time in CCI4 at 30° C. represents the extent of stress elimination of the 3D-printed object of PC.

In view of the comparison of the embodiment 1 with the embodiment 4, the comparison of the embodiment 2 with the embodiment 5, and the comparison of the embodiment 3 with the embodiment 6, there is no great change of the appearance of the 3D-printed object being heat-treated by the process of the invention. There is no deformation of the 3D-printed object because stress of the 3D-printed object is eliminated, tensile strength is increased, size is more stable, and appearance of the heat-treated 3D-printed object is not adversely affected in the step of removing the 3D-printed object from the solid capsule. The disequilibrium conformation of the 3D-printed object changes to an equilibrium state with the environment. Further, in the heat-treating step, the solid capsule limits the conversion from the disequilibrium conformation of the crystalline polymer to the equilibrium conformation in a small space. As a result, deformation of the 3D-printed object is substantially avoided.

The process for heat treating a 3D-printed object of the invention can prevent polymer from being deformed when the polymer is exposed to high heat-treating temperature. Thus, deformation of the 3D-printed object is substantially avoided and stress of the 3D-printed object is eliminated.

It is envisaged by the invention that the higher the heat-treating temperature, the more significant of the movement of the molecules of the polymer. And in turn, disequilibrium conformation of the molecules of the polymer may change to an equilibrium state and the stress of the polymer is eliminated.

In view of the comparison of the embodiment 1 with the example 1 and the comparison of the embodiment 3 with the example 3, for a heat-treated 3D-printed object the greater the tensile strength, the greater the capability of the 3D-printed object withstanding stretch or pull. And in turn, the stress of the 3D-printed object is substantially eliminated. The increased Young's modulus represents the stiffness of the heat-treated 3D-printed object is improved and the mechanical strength thereof is increased greatly.

In view of the comparison of the embodiment 2 with the example 2, for a brittle material formed of PC there is no great change before and after heat treatment in terms of tensile strength and Young's modulus. But for a 3D-printed object formed of PC and being heat-treated its breaking time in CCI4 at 30° C. is greatly increased and this means the stress of the 3D-printed object is eliminated.

The stress of the polymer is liable to be eliminated when it is exposed to a heat treatment temperature greater than the glass transition temperature but less than the viscous flow temperature of the polymer in view of the above description.

In view of the comparison of the embodiment 1 with the example 1 and the comparison of the embodiment 3 with the example 3 both in terms of degree of crystallinity, for a crystalline polymer having amorphous regions molecules of the amorphous regions are rearranged to form a second crystallization when the crystalline polymer is exposed to a heat treatment temperature greater than the glass transition temperature but less than the viscous flow temperature of the crystalline polymer. As a result, density of the crystalline polymer is increased greatly, the molecules of the crystalline polymer are arranged much aligned, the mechanical strength of the crystalline polymer is increased greatly, and both tensile strength and Young's modulus are increased greatly. It is also found that when the heat treatment temperature approaches the viscous flow temperature of the amorphous regions of the crystalline polymer, it is liable of converting the amorphous regions into the crystalline regions. Thus, in a range of heat treatment temperature greater than the glass transition temperature but less than the viscous flow temperature of the crystalline polymer it is possible of changing the heat treatment temperature to be near the viscous flow temperature of the amorphous regions or away from the viscous flow temperature of the amorphous regions in order to form polymers having different percentages of degree of crystallinity.

The invention has the following advantageous effects in comparison with the conventional art: the amorphous regions of the heat-treated object become elastomeric state. The stress of the 3D-printed object is eliminated. The size of the 3D-printed object is more stable. The solid capsule with the 3D-printed object enclosed therein greatly decreases deformation of the 3D-printed object in the heat treatment. Further, the disequilibrium conformation of the 3D-printed object in the solid capsule changes to an equilibrium state. The heat treatment is particularly suitable for 3D-printed objects liable to deformation in a high temperature condition. Its operation is simple and effects are significant.

While the invention has been described in terms of preferred embodiments, those skilled in the art will recognize that the invention can be practiced with modifications within the spirit and scope of the appended claims.

What is claimed is:

1. A process for heat treating a 3D-printed object, comprising the steps of:
(a) enclosing a 3D-printed object in a semisolid capsule;
(b) curing the semisolid capsule to form a solid capsule wrapping around the 3D-printed object;
(c) heat-treating the solid capsule until amorphous regions of the 3D-printed object become elastomeric state;
(d) cooling the solid capsule; and
(e) removing the heat-treated 3D-printed object from the solid capsule.

2. The process of claim 1, wherein the 3D-printed object is made from a crystalline polymer having amorphous regions or an amorphous polymer.

3. The process of claim 1, wherein the 3D-printed object is made from a crystalline polymer having amorphous regions, and wherein the heat-treating is taken at a temperature greater than a glass transition temperature but less than a viscous flow temperature of the crystalline polymer.

4. The process of claim 3, wherein the crystalline polymer is at least one of poly-ether-ether-ketone (PEEK) and a composite material thereof, a polyamide (PA) and a composite material thereof, and polyethylene terephthalate (PET) and a composite material thereof.

5. The process of claim 1, wherein the 3D-printed object is made from an amorphous polymer, and wherein the heat-treating is taken at a temperature greater than a glass transition temperature but less than a viscous flow temperature of the amorphous polymer.

6. The process of claim 1, wherein the semisolid capsule is gypsum emulsion, sodium metasilicate, silicone, or a combination thereof.

7. The process of claim 1, wherein the heat-treating is air heating, radiation heating, liquid heating, induction heating, or a combination thereof.

8. The process of claim 1, further comprising the step of removing gas molecules from the semisolid capsule prior to step (c) of curing the semisolid capsule.

9. The process of claim 1, wherein step (e) of removing the heat-treated 3D-printed object from the solid capsule involves knocking or pressurized washing the solid capsule, or dissolving the solid capsule in a chemical solution.

10. The process of claim 1, wherein the heat-treating is taken by increasing temperature at a rate of 20-200° C. per hour, and wherein after temperature has reached 200° C., the temperature is kept for 1 to 5 hours.
